(19) United States
(12) Patent Application Publication
(10) Pub. No.: US 2017/0239820 A1
(43) Pub. Date: Aug. 24, 2017

(54) ROBOT ARM

(71) Applicant: JTEKT CORPORATION, Osaka-shi (JP)

(72) Inventor: Hiromichi OHTA, Kariya-shi (JP)

(73) Assignee: JTEKT CORPORATION, Osaka-shi (JP)

(21) Appl. No.: 15/434,769

(22) Filed: Feb. 16, 2017

(30) Foreign Application Priority Data
Feb. 23, 2016 (JP) 2016-031836

(51) Int. Cl. B25J 17/02; B25J 18/02

(52) U.S. Cl. CPC B25J 17/0275; B25J 18/025

(57) ABSTRACT

A robot arm includes a second coupling rod fixedly coupled to a second intermediate base at an end of the second coupling rod located closer to the second intermediate base and coupled to a tip base via a second joint at an end of the second coupling rod located closer to the tip base so as to enable the second coupling rod to turn with respect to the tip base, and the first intermediate base and the second intermediate base are coupled together via an intermediate joint so as to be able to turn. The robot arm also includes a turning actuator that turns the second intermediate base with respect to the first intermediate base.

### INCORPORATION BY REFERENCE

The disclosure of Japanese Patent Application No. 2016-031836 filed on Feb. 23, 2016 including the specification, drawings and abstract, is incorporated herein by reference in its entirety.

### BACKGROUND OF THE INVENTION

1. Field of the Invention

The invention relates to a robot arm that performs the same functions as those of a human arm.

2. Description of the Related Art

A robot arm as illustrated in Japanese Patent Application Publication No. 2003-172418 (JP 2003-172418 A) will be described based on FIG. 9. The robot arm includes a plurality of bases arranged in the following order: a root base 201, a first intermediate base 202, a second intermediate base 203, and a tip base 204. The root base 201 and the first intermediate base 202 are coupled together via a first coupling rod 210. The second intermediate base 203 and the tip base 204 are coupled together via a second coupling rod 215. The root base 201 and the first intermediate base 202 are coupled together via three first telescopic actuators 220 arranged around the first coupling rod 210. The second intermediate base 203 and the tip base 204 are coupled together via three second telescopic actuators 225 arranged around the second coupling rod 215. Each of the three first telescopic actuators 220 is extended and contracted to vary the position and attitude of the first intermediate base 202 with respect to the root base 201. Each of the three second telescopic actuators 225 is extended and contracted to vary the position and attitude of the tip base 204 with respect to the second intermediate base 203.

The robot arm is further configured as follows. The first intermediate base 202 and the second intermediate base 203 are fixedly coupled together. An end of the first coupling rod 210 located closer to the first intermediate base 202 is fixedly coupled to the first intermediate base 202. An end of the first coupling rod 210 located closer to the root base 201 is coupled to the root base 201 via a first joint 211 so as to be able to turn with respect to the root base 201. An end of the second coupling rod 215 located closer to the second intermediate base 203 is coupled to the second intermediate base 203 via a second joint 216 so as to be able to turn with respect to the second intermediate base 203. An end of the second coupling rod 215 located closer to the tip base 204 is fixedly coupled to the tip base 204.

The robot arm is further configured as follows. First ends of the first telescopic actuators 220 are coupled to the root base 201 via respective third joints 221. Second ends of the first telescopic actuators 220 are coupled to the first intermediate base 202 via respective fourth joints 222. First ends of the second telescopic actuators 225 are coupled to the second intermediate base 203 via respective fifth joints 226. Second ends of the second telescopic actuator 225 are coupled to the tip base 204 via respective sixth joints 227.

In a robot arm illustrated in Japanese Patent Application Publication No. 2003-311667 (JP 2003-311667 A), a root base, an intermediate base, and a tip base are arranged in this order. The root base and the intermediate base are coupled together via six first telescopic actuators. The intermediate base and the tip base are coupled together via six second telescopic actuators. Each of the first telescopic actuators is extended and contracted to vary the position and attitude of the intermediate base with respect to the root base. Each of the second telescopic actuators is extended and contracted to vary the position and attitude of the tip base with respect to the intermediate base.

The robot arm as illustrated in JP 2003-172418 A is unable to make a motion similar to a human motion of bending the wrist, that is, a motion of turning the tip base with respect to the second coupling rod, and is also unable to make a motion similar to a human motion of bending the elbow, that is, a motion of turning the second intermediate base with respect to the first intermediate base.

The robot arm as illustrated in JP 2003-311667 A can make a motion similar to the human motion of bending the wrist, that is, a motion of turning the tip base around a virtual axis by extending and contracting the six second telescopic actuators. However, the motion is of course based on the virtual axis and not on a mechanical shaft. Therefore, axial runout is likely to occur due to mechanical backlash of the second telescopic actuators or mechanical backlash of the joints connected to the respective ends of each of the second telescopic actuators. The robot arm as illustrated in JP 2003-311667 A can make a motion similar to the human motion of bending the elbow, that is, a motion of turning the second intermediate base around a virtual axis with respect to the first intermediate base by extending and contracting the six first telescopic actuators. However, the motion is of course based on the virtual axis and not on a mechanical shaft. Therefore, axial runout is likely to occur due to mechanical backlash of the first telescopic actuators or mechanical backlash of the joints connected to the respective ends of each of the first telescopic actuators. The robot arm as illustrated in JP 2003-311667 A is also unable to make a motion similar to a human motion of turning the shoulder, that is, a motion of turning the root base.

### SUMMARY OF THE INVENTION

An object of the invention is to provide a robot arm that can make motions similar to motions of the human arm and that can thus perform human operations without change instead of human beings.

A robot arm in an aspect of the invention includes a root base, a first intermediate base, a second intermediate base, a tip base, a first coupling rod, a second coupling rod, three first telescopic actuators, three second telescopic actuators, and a turning actuator. The root base, the first intermediate base, the second intermediate base, and the tip base are arranged in this order. The root base and the first intermediate base are coupled together via the first coupling rod, and the second intermediate base and the tip base are coupled together via the second coupling rod. The root base and the first intermediate base are coupled together via the three first telescopic actuators arranged around the first coupling rod, and the second intermediate base and the tip base are coupled together via the three second telescopic actuators arranged around the second coupling rod. Each of the three first telescopic actuators is extended and contracted to vary a position and an attitude of the first intermediate base with respect to the root base. Each of the three second telescopic actuators is extended and contracted to vary a position and an attitude of the tip base with respect to the second intermediate base. An end of the first coupling rod located closer to the first intermediate base is fixedly coupled to the first intermediate base, and an end of the first coupling rod located closer to the root base is coupled to the root base via a first joint so as to be able to turn with respect to the root base. An end of the second coupling rod located closer to the second intermediate base is fixedly coupled to the second intermediate base, and an end of the second coupling rod located closer to the tip base is coupled to the tip base via a second joint so as to be able to turn with respect to the tip base. The first intermediate base and the second intermediate base are coupled together via an intermediate joint so as to be able to turn. The turning actuator turns the second intermediate base with respect to the first intermediate base.

This configuration enables a motion of turning the first coupling rod with respect to the root base via the first joint, that is, a motion similar to a human motion of turning the shoulder. The configuration also enables a motion of turning the second intermediate base with respect to the first intermediate base via the intermediate joint, that is, a motion similar to a human motion of bending the elbow. The configuration further enables a motion of turning the tip base with respect to the second coupling rod via the second joint, that is, a motion similar to a human motion of bending the wrist.

A robot arm in another aspect of the invention includes a root base, a first intermediate base, a second intermediate base, a tip base, a first coupling rod, a second coupling rod, three first telescopic actuators, three second telescopic actuators, a robot control apparatus, and a turning actuator. The root base, the first intermediate base, the second intermediate base, and the tip base are arranged in this order. The root base and the first intermediate base are coupled together via the first coupling rod, and the second intermediate base and the tip base are coupled together via the second coupling rod. The root base and the first intermediate base are coupled together via the three first telescopic actuators arranged around the first coupling rod, and the second intermediate base and the tip base are coupled together via the three second telescopic actuators arranged around the second coupling rod. First ends of the three first telescopic actuators are coupled to the root base via third joints so as to be able to turn with respect to the root base, and second ends of the three first telescopic actuators are coupled to the first intermediate base via fourth joints so as to be able to turn with respect to the first intermediate base. First ends of the three second telescopic actuators are coupled to the second intermediate base via fifth joints so as to be able to turn with respect to the second intermediate base, and second ends of the three second telescopic actuators are coupled to the tip base via sixth joints so as to be able to turn with respect to the tip base. The robot control apparatus controls the three first telescopic actuators and the three second telescopic actuators to vary a position and an attitude of the first intermediate base with respect to the root base and to vary a position and an attitude of the tip base with respect to the second intermediate base. An end of the first coupling rod located closer to the first intermediate base is fixedly coupled to the first intermediate base, and an end of the first coupling rod located closer to the root base is coupled to the root base via a first joint so as to be able to turn with respect to the root base. An end of the second coupling rod located closer to the second intermediate base is fixedly coupled to the second intermediate base, and an end of the second coupling rod located closer to the tip base is coupled to the tip base via a second joint so as to be able to turn with respect to the tip base. The first intermediate base and the second intermediate base are coupled together via an intermediate joint so as to be able to turn. The turning actuator turns the second intermediate base with respect to the first intermediate base. Three-axis universal joints each having three axes of rotation intersecting one another are used for either the third joints or the fourth joints, and the three-axis universal joints or two-axis universal joints each having two axes of rotation intersecting each other are used for the other of the third joints and the fourth joints, the three-axis universal joints are used for either the fifth joints or the sixth joints, and the three-axis universal joints or the two-axis universal joints are used for the other of the fifth joints and the sixth joints.

In this configuration, even when the first intermediate base is rotated around an axis of the first coupling rod with respect to the root base and the first coupling rod is rotated around an axis orthogonal to the axis of the first coupling rod, possible internal interference of the three-axis universal joint itself can be avoided because the three-axis universal joint has the three axes of rotation intersecting one another to share an amount of turning. Even when the tip base is rotated around an axis of the second coupling rod with respect to the second intermediate base and the tip base is rotated around an axis orthogonal to the axis of the second coupling rod, possible internal interference of the three-axis universal joint itself can be avoided because the three-axis universal joint has the three axes of rotation intersecting one another to share an amount of turning.

Even when, instead of the three-axis universal joints, the two-axis universal joints are used for either the third joints or the fourth joints, or instead of the three-axis universal joints, the two-axis universal joints are used for either the fifth joints or the sixth joints, insufficient motions of the two-axis universal joints can be covered by the three-axis universal joints that correspond to the other of the third joints and the fourth joints and the three-axis universal joints that correspond to the other of the fifth joints and the sixth joints. Furthermore, possible internal interference of the two-axis universal joint itself can be avoided because the two-axis universal joint has the two axes of rotation intersecting each other to share an amount of turning.

The aspects of the invention can provide a robot arm that can make motions similar to motions of the human arm and that can thus perform human operations without change instead of human beings.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a side view of a robot arm in an embodiment of the invention;

FIG. 2 is a side view of a root base side portion of the robot arm in the embodiment of the invention;

FIG. 3 is a side view of a tip base side portion of the robot arm in the embodiment of the invention;

FIG. 4 is a side view of the embodiment of the invention as viewed in the direction of arrow A depicted in FIG. 1;

FIG. 5 is a sectional view of a joint of the robot arm in the embodiment of the invention;

FIG. 6 is a sectional view of a joint of the robot arm in another embodiment of the invention;

FIG. 7 is a schematic diagram illustrating an operation of the root base side portion of the robot arm in the embodiment of the invention;

FIG. 8 is a side view of a portion between a first intermediate base and a second intermediate base of a robot arm in another embodiment of the invention; and

FIG. 9 is a perspective view of a conventional robot arm.

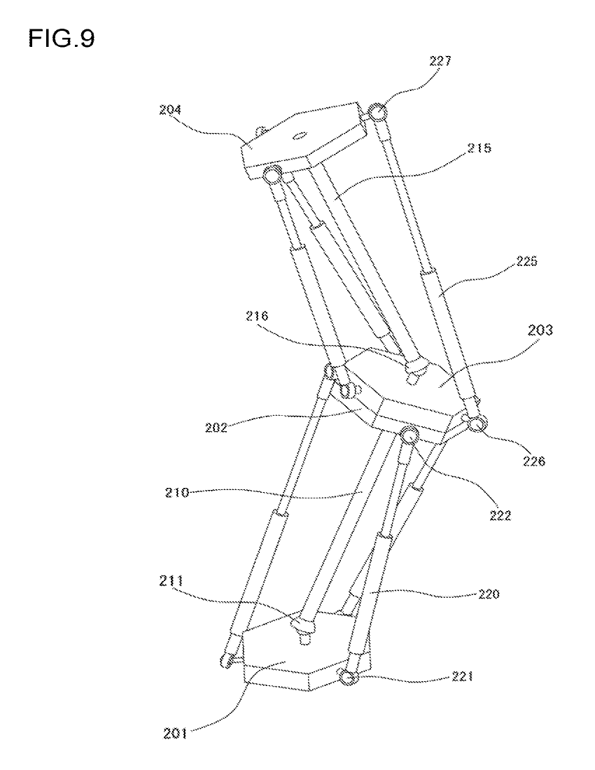

### DETAILED DESCRIPTION OF EMBODIMENTS

Embodiments of the invention will be described below with reference to the attached drawings.

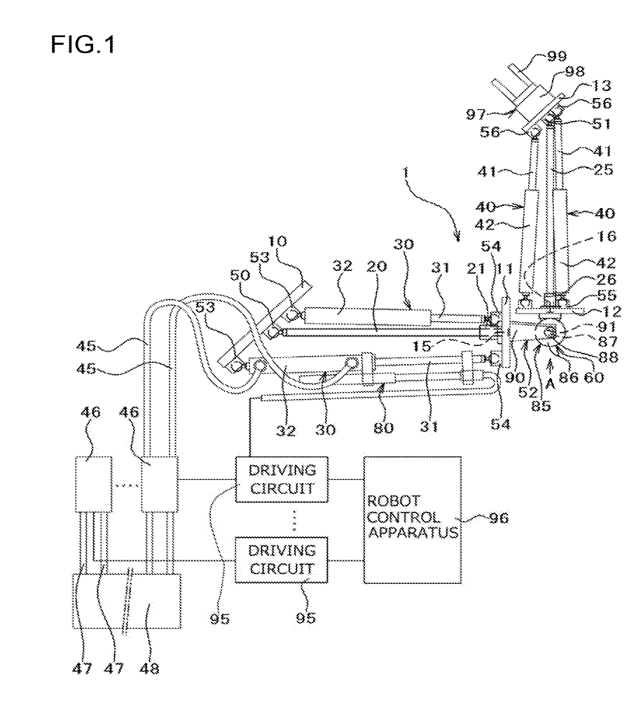

As depicted in FIG. 1, a robot arm 1 includes a root base 10, a first intermediate base 11, a second intermediate base 12, and a tip base 13 that are arranged in this order from a root to a tip of the robot arm 1.

The robot arm 1 also includes a first coupling rod 20 that couples the root base 10 and the first intermediate base 11 together, a second coupling rod 25 that couples the second intermediate base 12 and the tip base 13 together, three first telescopic actuators 30 that connect the root base 10 and the first intermediate base 11 together and that are arranged around the first coupling rod 20, three second telescopic actuators 40 that connect the second intermediate base 12 and the tip base 13 together and that are arranged around the second coupling rod 25, a first joint 50 that connects an end of the first coupling rod 20 located closer to the root base 10 to the root base 10 so as to enable the first coupling rod 20 to turn with respect to the root base 10, and a second joint 51 that couples an end of the second coupling rod 25 located closer to the tip base 13 to the tip base 13 so as to enable the second coupling rod 25 to turn with respect to the tip base 13.

The robot arm 1 further includes an intermediate joint 52 that couples the first intermediate base 11 and the second intermediate base 12 together so as to enable the first intermediate base 11 and the second intermediate base 12 to turn, and a turning actuator 60 that turns the second intermediate base 12 with respect to the first intermediate base 11.

The root base 10, the first intermediate base 11, the second intermediate base 12, and the tip base 13 are each shaped like a disc, and diameter and board thickness gradually decrease from the root base 10 toward the tip base 13.

The first coupling rod 20 is shaped like a rod, and a first end of the first coupling rod 20 is fitted into a sleeve member 21. The sleeve member 21 is cylindrical and has a flange portion located at a first end of the sleeve member 21 and protruding outward in a radial direction of the sleeve member 21. The flange portion of the sleeve member 21 is fixed to the center of the first intermediate base 11 in a radial direction thereof with bolts not depicted in the drawings. The first end of the first coupling rod 20 is fixed to the first intermediate base 11 via a bolt 15. A second end of the first coupling rod 20 is coupled via the first joint 50 to the center of the root base 10 in a radial direction thereof. The first coupling rod 20 is firmly fixedly coupled to the first intermediate base 11 via the sleeve member 21 and the bolt 15.

The second coupling rod 25 is shaped like a rod, and a first end of the second coupling rod 25 is fitted into a sleeve member 26. The sleeve member 26 is cylindrical and has a flange portion located at a first end of the sleeve member 26 and protruding outward in a radial direction of the sleeve member 26. The flange portion of the sleeve member 26 is fixed to the center of the second intermediate base 12 in a radial direction thereof via bolts not depicted in the drawings. The first end of the second coupling rod 25 is fixed to the second intermediate base 12 via a bolt 16. A second end of the second coupling rod 25 is coupled via the second joint 51 to the center of the tip base 13 in a radial direction thereof. The second coupling rod 25 is firmly fixedly coupled to the second intermediate base 12 via the sleeve member 26 and the bolt 16.

First ends of the first telescopic actuators 30 are coupled to a peripheral portion of the root base 10 via third joints 53. Second ends of the first telescopic actuators 30 are coupled to a peripheral portion of the first intermediate base 11 via fourth joints 54. The three third joints 53 are arranged at respective assigned positions in the peripheral portion of the root base 10 at regular intervals in a circumferential direction. The three fourth joints 54 are arranged at respective assigned positions in the peripheral portion of the first intermediate base 11 at regular intervals in a circumferential direction.

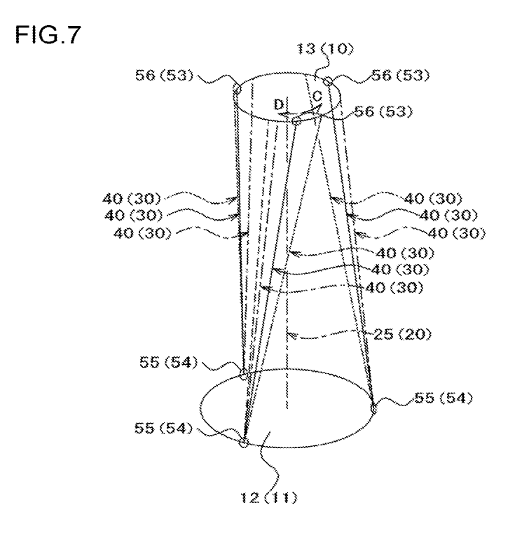

For convenience of drawing, the third joints 53 and the fourth joints 54 are depicted as if they are in phase as viewed from the centers of the root base 10 and the first intermediate base 11. However, the fourth joints 54 are actually arranged out of phase with the third joints 53 around the center of the first intermediate base 11 in one direction as viewed from the centers of the root base 10 and the first intermediate base 11. In other words, after the root base 10 and the first intermediate base 11 are coupled together with the first coupling rod 20 and the first telescopic actuators 30, the first intermediate base 11 is rotated around an axis of the first coupling rod 20 in one direction with respect to the root base 10, that is, the first telescopic actuators 30 are tilted around the axis of the first coupling rod 20 in a first direction as depicted by a continuous line (FIG. 7). The positions of the third joints 53 coupled to the first telescopic actuators 30 as depicted by continuous lines (FIG. 7) are assumed to be intermediate points. Then, extension of the first telescopic actuators 30 further rotates the root base 10 in the first direction (direction C) to set the first telescopic actuators 30 as depicted by long dashed double-short dashed lines (FIG. 7). In contrast, contraction of the first telescopic actuators 30 rotates the root base 10 in a second direction (direction D) to set the first telescopic actuators 30 as depicted by long dashed short dashed lines (FIG. 7).

The state depicted by a dashed line (FIG. 7) is an imaginary state where the third joints 53 and the fourth joints 54 are arranged in phase as viewed from the centers of the root base 10 and the first intermediate base 11. In this state, it is difficult to know whether the root base 10 rotates in the first direction C or the second direction D as a result of extension of the first telescopic actuators 30, so the robot arm may be uncontrollable. Therefore, the third joints 53 are controlled to be kept out of phase with the fourth joints 54 around the center of the root base 10 in the first direction so that rotation of the root base 10 in the second direction D does not set the first telescopic actuators 30 as depicted by the dashed line (FIG. 7). This prevents the root base 10 from rotating beyond the dashed line (FIG. 7) in the second direction D, thus preventing the robot arm from being uncontrollable.

First ends of the second telescopic actuators 40 are coupled to a peripheral portion of the second intermediate base 12 via fifth joints 55. Second ends of the second telescopic actuators 40 are coupled to a peripheral portion of the tip base 13 via sixth joints 56. The three fifth joints 55 are arranged at assigned positions in the peripheral portion of the second intermediate base 12 at regular intervals in the circumferential direction. The three sixth joints 56 are arranged at assigned positions in the peripheral portion of the tip base 13 at regular intervals in the circumferential direction.

As is the case with the first telescopic actuators 30, the fifth joints 55 and the sixth joints 56 are depicted as if they are in phase as viewed from the centers of the second intermediate base 12 and the tip base 13 for convenience of drawing, but the sixth joints 56 are actually arranged out of phase with the fifth joints 55 around the center of the tip base 13 in one direction as viewed from the centers of the second intermediate base 12 and the tip base 13. Operations of the second telescopic actuators 40 are the same as the operations of first telescopic actuators 30 and will thus not be described. For the second telescopic actuators 40, the tip base 13 is prevented from rotating beyond the dashed line (FIG. 7) in the second direction, thus preventing the robot arm from being uncontrollable as is the case with the above-described first telescopic actuators 30.

The first telescopic actuators 30 and the second telescopic actuators 40 are each a hydraulic cylinder. The second telescopic actuators 40 have a shorter cylinder stroke and a smaller cylinder diameter than the first telescopic actuators 30. Each of the first telescopic actuators 30 includes a first piston rod 31 and a first cylinder 32 into which a piston (not depicted in the drawings) of the first piston rod 31 is fitted so as to be movable forward and backward. Each of the second telescopic actuators 40 includes a second piston rod 41 and a second cylinder 42 into which a piston (not depicted in the drawings) of the first piston rod 31 is fitted so as to be movable forward and backward. The first cylinder 32 and the second cylinder 42 each have a cylinder chamber not depicted in the drawings and partitioned into two chambers by the piston. The first piston rod 31 and the second piston rod 41 are moved with respect to the first cylinder 32 and the second cylinder 42 by feeding oil into one of the two chambers and discharging oil from the other chamber.

The first joint 50, the second joint 51, the third joints 53, the fourth joints 54, the fifth joints 55, and the sixth joints 56 are each a ball joint 70. The ball joint 70 will be described in detail by taking the third joints 53 as an example.

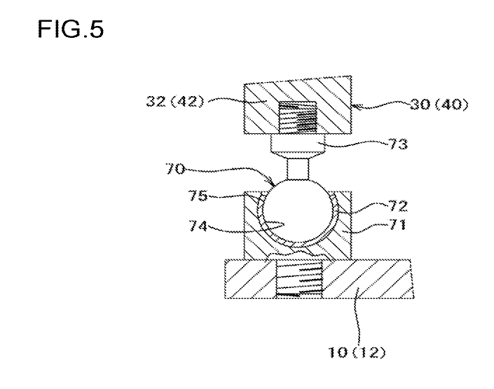

As depicted in FIG. 5, the ball joint 70 includes a socket member 71 threadably coupled to the root base 10, a seat member 72 arranged in the socket member 71, and a ball stud member 73 threadably coupled to the first end of the corresponding first telescopic actuator 30. A protruding spherical surface 75 of the ball stud member 73 is slidably fitted onto a recessed spherical surface 74 formed by a combination of the socket member 71 and the seat member 72 to couple the ball stud member 73 to the socket member 71 so as to enable the ball stud member 73 to turn around a single point.

As depicted in FIG. 1, a linear displacement sensor 80 is attached to each of the three first telescopic actuators 30 and to each of the three second telescopic actuators 40. The linear displacement sensor 80 includes a scale not depicted in the drawings and a read head not depicted in the drawings. The read head moves along the scale so that the linear displacement sensor 80 can sense the position of the read head with respect to the scale. The read head is attached to each first piston rod 31 and to each second piston rod 41, and the scale is attached to each first cylinder 32 and to each second cylinder 42.

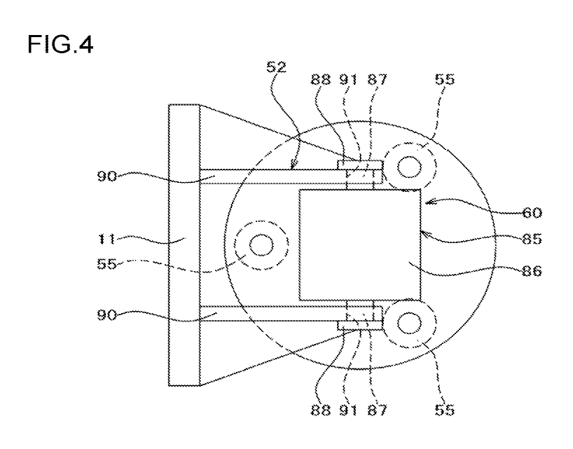

As depicted in FIG. 1 and FIG. 4, a rotating cylinder 85 is attached to a first intermediate base 11-side surface of the second intermediate base 12. The rotating cylinder 85 includes a cylinder main body 86 fixed to the second intermediate base 12 and a rotating shaft 87 supported by the cylinder main body 86 via a bearing not depicted in the drawings, so as to be able to turn.

A rotating piston not depicted in the drawings is integrally coupled to the rotating shaft 87. A cylinder chamber not depicted in the drawings is formed in the cylinder main body 86 to house the rotating piston so as to enable the rotating piston to turn over an angular range from 0 degree to 180 degrees. The cylinder chamber is partitioned into two chambers by the rotating piston. The rotating shaft 87 is turned in a first direction with respect to the cylinder main body 86 by feeding oil into one of the two chambers and discharging oil from the other chamber. A pair of brackets 90 is provided on a second intermediate base 12-side surface of the first intermediate base 11 such that the cylinder main body 86 is sandwiched between the brackets 90. Support holes 91 are formed in the brackets 90 so as to penetrate the brackets 90, with rotating shaft 87 inserted through the support holes 91. Disc-shaped coupling plates 88 are fixed to opposite ends of the rotating shaft 87 via bolts not depicted in the drawings. The coupling plates 88 are each fixed to the corresponding bracket 90 at a peripheral portion of the coupling plate 88 via bolts not depicted in the drawings.

The rotating cylinder 85, the pair of brackets 90, and the coupling plates 88 form the intermediate joint 52 that couples the first intermediate base 11 and the second intermediate base 12 together so as to enable the first intermediate base 11 and the second intermediate base 12 to turn. The rotating cylinder 85, the pair of brackets 90, and the coupling plates 88 form the turning actuator 60 that turns the second intermediate base 12 with respect to the first intermediate base 11.

The cylinder main body 86 has a built-in encoder (not depicted in the drawings) detecting the amount of turning of the rotating shaft 87 with respect to the cylinder main body 86.

As depicted in FIG. 1, a hand apparatus 97 is attached to the tip base 13. The hand apparatus 97 includes a hand main body 98 attached to the tip base 13 and a plurality of pawls 99 that is opened and closed by a pawl actuator built into the hand main body 98 and not depicted in the drawings.

A configuration of a hydraulic circuit will be described based on FIG. 1.

A pair of first hydraulic hoses 45 is connected to each of the rotating cylinder 85, the three first telescopic actuators 30, the three second telescopic actuators 40, and the pawl actuator. A servo valve 46 is connected to the pair of first hydraulic hoses 45, and a pair of second hydraulic hoses 47 is connected to the servo valve 46. A hydraulic source 48 is connected to the pair of second hydraulic hoses 47. The hydraulic source 48 includes a pump apparatus that supplies pressure oil to the servo valves 46 and a tank in which oil discharged from the servo valves 46 is collected.

The pair of first hydraulic hoses 45, the servo valve 46, and the pair of second hydraulic hoses 47 are provided for each of the rotating cylinder 85, the three first telescopic actuators 30, the three second telescopic actuators 40, and the pawl actuator. The one hydraulic source 48 is shared by the pair of first hydraulic hoses 45, the servo valve 46, the pair of second hydraulic hoses 47.

A configuration of a control circuit will be described based on FIG. 1.

A plurality of driving circuits 95 is provided the number of which is equal to the total number of the rotating cylinder 85, the three first telescopic actuators 30, the three second telescopic actuators 40, and the pawl actuator. The driving circuits 95 are electrically connected to the servo valves 46 based on a one-to-one relation. The driving circuits 95 are electrically connected to the robot control apparatus 96, which thus transmits command signals to the driving circuits 95. The driving circuits 95 are electrically connected to the linear displacement sensors 80 and the encoders on a one-to-one relation. The driving circuits 95 each generate a current signal based on a difference between a command signal from the robot control apparatus 96 and an actual signal from the linear displacement sensor 80 and the encoder, and apply the current signal to the servo valve 46.

The robot control apparatus 96 stores a series of operations performed only by human arms, that is, the attitudes and positions of a human first arm with respect to a human shoulder, the attitudes and positions of a human second arm with respect to the first arm, and the attitudes and positions of a human wrist with respect to the second arm, during the series of operations. The robot control apparatus 96 calculates and stores the attitudes and positions of the first intermediate base with respect to the root base, the attitudes and positions of the second intermediate base with respect to the first intermediate base, and the attitudes and positions of the tip base with respect to the second intermediate base based on the attitudes and positions of the first arm with respect to the shoulder, the attitudes and positions of the second arm with respect to the first arm, and the attitudes and positions of the wrist with respect to the second arm. To move the robot arm 1, the rotating cylinder 85, the three first telescopic actuators 30, and the three second telescopic actuators 40 are moved using the calculated and stored attitudes and positions.

Operations of the robot arm 1 will be described based on the above-described configuration.

The robot control apparatus 96 stores the series of operations and sequentially executes steps of the operations. To shift one step to the next step, the robot control apparatus 96 invokes the attitudes and positions of the first intermediate base with respect to the root base, the attitudes and positions of the second intermediate base with respect to the first intermediate base, and the attitudes and positions of the tip base with respect to the second intermediate base, and transmits the attitudes and positions to the driving circuits 95 as command signals. The driving circuits 95 each generate a driving current based on the difference between the command signal from the robot control apparatus 96 and the actual signal from the linear displacement sensor 80 and the encoder, and apply the driving current to the servo valve 46.

The servo valves 46 are used to feed oil to one of two chambers of a cylinder chamber in each of the rotating cylinder 85, the three first telescopic actuators 30, the three second telescopic actuators 40 and the pawl actuator, while discharging oil from the other chamber. The servo valves 46 are used to further control the amount of oil fed and the amount of oil discharged and to stop feeding and discharging.

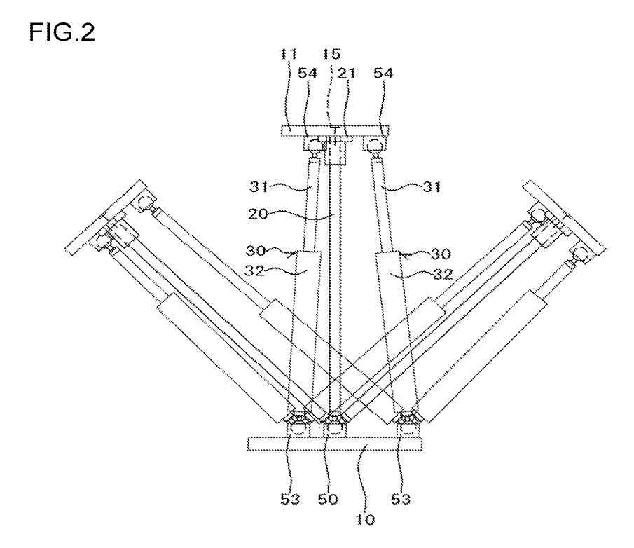

Controlling feeding and discharging of oil to and from the three first telescopic actuators 30 allows the position and attitude of the first intermediate base 11 with respect to the root base 10 to be varied around a single point of the first joint 50 as depicted in FIG. 2. That is, the first coupling rod 20 and the first intermediate base 11 are turned around a single point of the first joint 50, and this corresponds to a human motion of turning the arm around the shoulder. The first joint 50 has a turning center for single point turning, thus facilitating a motion of turning of the first intermediate base 11.

Controlling feeding and discharging of oil to and from the rotating cylinder 85 allows the attitude of the second intermediate base 12 with respect to the first intermediate base 11 to be varied around an axis of rotation of the rotating shaft 87. That is, the second intermediate base 12 and the second coupling rod 25 are turned around the axis of rotation of the rotating shaft 87 with respect to the first intermediate base 11 and the first coupling rod 20. This corresponds to a human motion of turning the second arm around the elbow with respect to the first arm. The intermediate joint 52 has a turning axis that coincides with the axis of rotation of the rotating shaft 87, thus suppressing axial run-out and facilitating a motion of turning the second intermediate base 12.

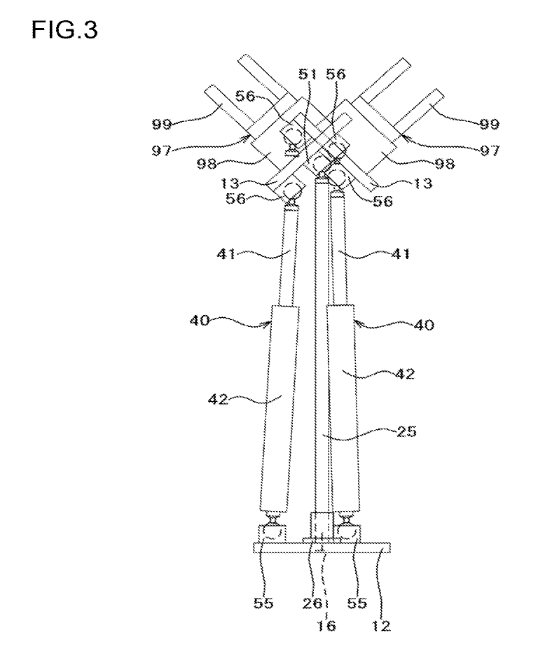

Controlling feeding and discharging of oil to and from the three second telescopic actuators 40 allows the position and attitude of the tip base 13 with respect to the second intermediate base 12 to be varied around a single point of the second joint 51 as depicted in FIG. 3. That is, the tip base 13 is turned around a single point of the second joint 51 with respect to the second coupling rod 25, and this corresponds to a human motion of bending the wrist. The second joint 51 has a turning center for single point turning, thus facilitating a motion of turning of the tip base 13.

In the above-described embodiment, by way of example, the ball joint 70 is used for each of the first joint 50, the second joint 51, the third joints 53, the fourth joints 54, the fifth joints 55, and the sixth joints 56. In another embodiment, a three-axis universal joint 120 having three axes of rotation may be used for each of the third joints 53, the fourth joints 54, the fifth joints 55, and the sixth joints 56. An example will be described in detail in which the three-axis universal joint 120 is used for each of the third joints 53.

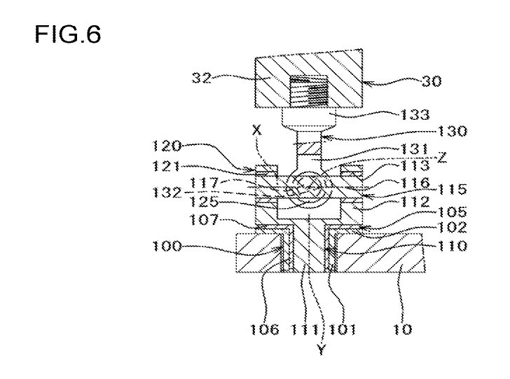

In FIG. 6, the three-axis universal joint 120 includes a sleeve member 100 threadably coupled to the root base 10, a first seat member 105, an intermediate member 110 supported so as to be able to turn around a first axis of rotation Y via a first seat member 105 with respect to the sleeve member 100, a second seat member 121, a cross member 115 supported so as to be able to turn around a second axis of rotation X via the second seat member 121 with respect to the intermediate member 110, a third seat member 125, and a rod member 130 supported so as to be able to turn around a third axis of rotation Z via the third seat member 125 with respect to the cross member 115.

The sleeve member 100 includes a cylindrical portion 101 shaped like a cylinder and a flange portion 102 located at a first end of the cylindrical portion 101 and extending outward in a radial direction of the sleeve member 100. An external thread is formed on an outer periphery of the cylindrical portion 101 and screw-threaded through an internal thread on the root base 10.

The first seat member 105 is fitted on an outer periphery of the cylindrical portion 101. The first seat member 105 includes a cylindrical portion 106 shaped like a cylinder and a flange portion 107 located at a first end of the cylindrical portion 106 and extending outward in a radial direction of the first seat member.

The intermediate member 110 includes a shaft portion 111 rotatably fitted on an inner periphery of the cylindrical portion 106 and a bifurcated portion 112 having a bifurcated shape. A support hole 113 is formed in the bifurcated portion 112, and the cylindrical second seat member 121 is fitted in the support hole 113. A first shaft portion 116 of the cross member 115 is rotatably fitted on an inner periphery of the second seat member 121. The cross member 115 has the first shaft portion 116 and a second shaft portion 117 that are orthogonal to each other.

A cylindrical third seat member 125 is fitted on the second shaft portion 117, and the third seat member 125 is arranged on a bifurcated portion 131 of the rod member 130. The rod member 130 includes the bifurcated portion 131 having a bifurcated shape and a shaft portion 133. A support hole 132 is formed in the bifurcated portion 131, and the third seat member 125 is fitted in the support hole 132. The shaft portion 133 is threadably coupled to the first cylinder 32 of each first telescopic actuator 30.

The first axis of rotation Y and the second axis of rotation X are orthogonal to each other. The second axis of rotation X and the third axis of rotation Z are orthogonal to each other. The intermediate member 110 can turn through ±180 degrees around the first axis of rotation Y with respect to the sleeve member 100. The cross member 115 can turn through approximately ±45 degrees around the second axis of rotation X with respect to the intermediate member 110. The rod member 130 can turn through approximately ±45 degrees around the third axis of rotation Z with respect to the cross member 115. Even when torsion of the first intermediate base 11 with respect to the root base 10 in one direction is intensified, that is, even when the amount of rotation of the first intermediate base 11 around the axis of the first coupling rod 20 with respect to the root base 10 is increased, the axes of rotation of the three-axis universal joint 120 share the amount of turning and possible interference of the three-axis universal joint 120 itself can be avoided. In other words, possible interference between the intermediate member 110 and the rod member 130 can be avoided. Even when torsion of the tip base 13 with respect to the second intermediate base 12 in one direction is intensified, that is, even when the amount of rotation of the tip base 13 around the axis of the second coupling rod 25 with respect to the second intermediate base 12 is increased, the axes of rotation of the three-axis universal joint 120 share the amount of turning and possible interference of the three-axis universal joint 120 itself can be avoided. In other words, possible interference between the intermediate member 110 and the rod member 130 can be avoided.

The ball joint 70 has a simple structure and turns around a single point, thus simplifying relevant calculations to allow the ball joint 70 to be easily controlled. On the other hand, the ball joint 70 has a small turning angle and is unable to intensify torsion of the first intermediate base 11 with respect to the root base 10 or torsion of the tip base 13 with respect to the second intermediate base 12, that is, to increase the amount of displacement of the fourth joints 54 around the center of the first intermediate base 11 in one direction with respect to the third joints 53 or the amount of displacement of the sixth joints 56 around the center of the tip base 13 in one direction with respect to the fifth joints 55.

The three-axis universal joint 120 has a complicated structure and turns around a plurality of axes of rotation, thus complicating relevant calculations to make control of the three-axis universal joint 120 difficult. On the other hand, the three-axis universal joint 120 has a large turning angle to allow intensification of torsion of the first intermediate base 11 with respect to the root base 10 and torsion of the tip base 13 with respect to the second intermediate base 12.

In the above-described embodiment, by way of example, the three-axis universal joint 120 having three axes of rotation is used for each of the third joints 53, the fourth joints 54, the fifth joints 55, and the sixth joints 56. In another embodiment, two-axis universal joints each having two axes of rotation intersecting each other may be used for either the third joints 53 or the fourth joints 54 and for either the fifth joints 55 or the sixth joints 56. The two-axis universal joint corresponds to the three-axis universal joint 120 depicted in FIG. 6, in which rotation around the third axis of rotation Z is prohibited. That is, the second shaft portion 117 and the bifurcated portion 131 in FIG. 6 are integrated together. Even when, instead of the three-axis universal joints, the two-axis universal joints are used for either the third joints or the fourth joints, or instead of the three-axis universal joints, the two-axis universal joints are used for either the fifth joints or the sixth joints, insufficient motions of the two-axis universal joints can be covered by the three-axis universal joints that correspond to the other of the third joints and the fourth joints and the three-axis universal joints that correspond to the other of the fifth joints and the sixth joints. Furthermore, possible internal interference of the two-axis universal joint itself can be avoided because the two-axis universal joint has the two axes of rotation intersecting each other to share an amount of turning.

In the above-described embodiment, the servo valves 46 are used to perform selective control so as to feed oil to one of the two chambers of the cylinder chamber in each of the rotating cylinder 85, the three first telescopic actuators 30, the three second telescopic actuators 40, and the pawl actuator, while discharging oil from the other chamber, thus controlling the amount of oil fed and the amount of oil discharged. The servo valves 46 are used to further controllably stop feeding and discharging oil to and from the two chambers of the cylinder chamber in each of the rotating cylinder 85, the three first telescopic actuators 30, the three second telescopic actuators 40, and the pawl actuator. In other words, the servo valves 46 perform three types of control, selective control, amount control, and stop control. In another embodiment, a directional control valve and a flow control valve may be used instead of the servo valves 46. The directional control valve is used to perform selective control that allows oil to be fed to one of the chambers while allowing oil to be discharged from the other chamber, and to perform stop control that allows feeding and discharging of oil to and from the two chambers to be stopped. The flow control valve is used to perform amount control that allows the amount of oil fed and the amount of oil discharged to be controlled.

In the above-described embodiment, by way of example, hydraulic cylinders are used for the first telescopic actuators 30 and for the second telescopic actuators 40. In another embodiment, the first telescopic actuators 30 and the second telescopic actuators 40 may be ball screw mechanisms with electric motors in which a ball screw is rotated by an electric motor so that linear motion of a ball nut is transmitted to the rod 31 and the rod 41.

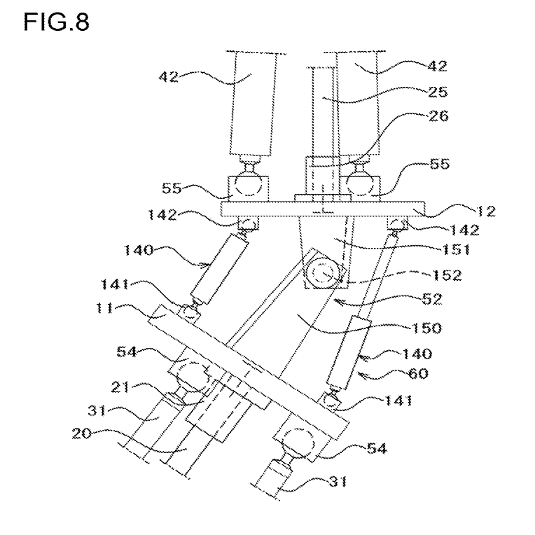

In the above-described embodiment, the rotating cylinder 85, the pair of brackets 90, and the coupling plates 88 form the intermediate joint 52 that couples the first intermediate base 11 and the second intermediate base 12 together so as to enable the first intermediate base 11 and the second intermediate base 12 to turn, and also form the turning actuator 60 that turns the second intermediate base 12 with respect to the first intermediate base 11. In another embodiment, instead of the rotating cylinder 85 in FIG. 1, linear motion cylinders 140 may be used as depicted in FIG. 8. The intermediate joint 52 may be configured to include a first bracket 150 provided on the first intermediate base 11, a second bracket 151 provided on the second intermediate base 12, and a coupling shaft 152 inserted and fitted into the first bracket 150 and the second bracket 151 so as to be slidably rotatable. At positions offset from an axis of the coupling shaft 152 of the intermediate joint 52, first ends of the linear motion cylinders 140 are coupled to the second intermediate base 12 via respective seventh joints 141, and second ends of the linear motion cylinders 140 are coupled to the first intermediate base 11 via respective eighth joints 142. The ball joint 70 may be used for each of the seventh joints 141 and the eighth joints 142. In this case, the linear motion cylinders 140 serve as the turning actuator 60.

What is claimed is:

1. A robot arm comprising:
a root base;
a first intermediate base;
a second intermediate base;
a tip base;
a first coupling rod;
a second coupling rod;
three first telescopic actuators;
three second telescopic actuators; and
a turning actuator, wherein
the root base, the first intermediate base, the second intermediate base, and the tip base are arranged in this order,
the root base and the first intermediate base are coupled together via the first coupling rod, and the second intermediate base and the tip base are coupled together via the second coupling rod,
the root base and the first intermediate base are coupled together via the three first telescopic actuators arranged around the first coupling rod, and the second intermediate base and the tip base are coupled together via the three second telescopic actuators arranged around the second coupling rod,
each of the three first telescopic actuators is extended and contracted to vary a position and an attitude of the first intermediate base with respect to the root base,
each of the three second telescopic actuators is extended and contracted to vary a position and an attitude of the tip base with respect to the second intermediate base,
an end of the first coupling rod located closer to the first intermediate base is fixedly coupled to the first intermediate base, and an end of the first coupling rod located closer to the root base is coupled to the root base via a first joint so as to be able to turn with respect to the root base,
an end of the second coupling rod located closer to the second intermediate base is fixedly coupled to the second intermediate base, and an end of the second coupling rod located closer to the tip base is coupled to the tip base via a second joint so as to be able to turn with respect to the tip base,
the first intermediate base and the second intermediate base are coupled together via an intermediate joint so as to be able to turn, and
the turning actuator turns the second intermediate base with respect to the first intermediate base.

2. A robot arm comprising:
a root base;
a first intermediate base;
a second intermediate base;
a tip base;
a first coupling rod;
a second coupling rod;
three first telescopic actuators;
three second telescopic actuators;
a robot control apparatus; and
a turning actuator, wherein
the root base, the first intermediate base, the second intermediate base, and the tip base are arranged in this order,
the root base and the first intermediate base are coupled together via the first coupling rod, and the second intermediate base and the tip base are coupled together via the second coupling rod,
the root base and the first intermediate base are coupled together via the three first telescopic actuators arranged around the first coupling rod, and the second intermediate base and the tip base are coupled together via the three second telescopic actuators arranged around the second coupling rod,
first ends of the three first telescopic actuators are coupled to the root base via third joints so as to be able to turn with respect to the root base, and second ends of the three first telescopic actuators are coupled to the first intermediate base via fourth joints so as to be able to turn with respect to the first intermediate base, first ends of the three second telescopic actuators are coupled to the second intermediate base via fifth joints so as to be able to turn with respect to the second intermediate base, and second ends of the three second telescopic actuators are coupled to the tip base via sixth joints so as to be able to turn with respect to the tip base,
the robot control apparatus controls the three first telescopic actuators and the three second telescopic actuators to vary a position and an attitude of the first intermediate base with respect to the root base and to vary a position and an attitude of the tip base with respect to the second intermediate base,
an end of the first coupling rod located closer to the first intermediate base is fixedly coupled to the first intermediate base, an end of the first coupling rod located closer to the root base is coupled to the root base via a first joint so as to be able to turn with respect to the root base,
an end of the second coupling rod located closer to the second intermediate base is fixedly coupled to the second intermediate base, and an end of the second coupling rod located closer to the tip base is coupled to the tip base via a second joint so as to be able to turn with respect to the tip base,
the first intermediate base and the second intermediate base are coupled together via an intermediate joint so as to be able to turn,
the turning actuator turns the second intermediate base with respect to the first intermediate base,
three-axis universal joints each having three axes of rotation intersecting one another are used for either the third joints or the fourth joints, and the three-axis universal joints or two-axis universal joints each having two axes of rotation intersecting each other are used for the other of the third joints and the fourth joints, the three-axis universal joints are used for either the fifth joints or the sixth joints, and the three-axis universal joints or the two-axis universal joints are used for the other of the fifth joints and the sixth joints.
